(19) United States
(12) Patent Application Publication
(10) Pub. No.: US 2016/0326353 A1
(43) Pub. Date: Nov. 10, 2016

(54) POLYMER BLEND: HDPE WITH ETHYLENE-NORBORNENE OR PROPYLENE NORBORNENE COPOLYMER

(71) Applicant: BOREALIS AG, Vienna (AT)

(72) Inventors: Floran PRADES, Linz (AT); Joy CHENG, Linz (AT)

(73) Assignee: BOREALIS AG, Vienna (AT)

(21) Appl. No.: 15/109,852

(22) PCT Filed: Jan. 5, 2015
(86) PCT No.: PCT/EP2015/050055

§ 371 Date: Jul. 6, 2016

(30) Foreign Application Priority Data
Jan. 6, 2014 (EP) 14150219.5

(51) Int. Cl. C08L 23/06; C08J 5/00

(52) U.S. Cl. CPC C08L 23/06; C08J 5/00; C08L 2207/062; C08L 2201/08; C08J 2323/06; C08J 2445/00; C08L 2205/02; B29C 45/0001

(57) ABSTRACT

A polymer composition comprising: (C) at least 80 wt % of a multimodal high density polyethylene having a density of 940 kg/m³ or more; and (D) 1 to 14 wt % of a cyclic ethylene copolymer or cyclic propylene copolymer.

The present invention relates to a polyethylene blend for injection moulded or compression moulded articles, in particular for the manufacture of caps and closures. The present invention also relates to an injection or compression moulded article comprising said blend and to the use of said blend for the production of an injection or compression moulded article such as a cap or closure. The blend of the invention comprises a multimodal high density polyethylene and a cyclic olefin copolymer (COC) which, when combined in particular weight ratios, enable the formation of injection or compression moulded articles with advantageous properties in terms of tensile modulus without loss of stress crack resistance and without causing shrinkage problems.

### BACKGROUND

Injection moulding may be used to make a wide variety of articles including articles having relatively complex shapes and a range of sizes. Injection moulding is, for instance, suited to the manufacture of articles used as caps and closures for food and drink applications, such as for bottles containing carbonated or non-carbonated drinks, or for non-food applications like containers for cosmetics and pharmaceuticals. Caps and closures may, however, also be made by compression moulding.

To reduce weight and also save money (down gauging), the industry strives for lighter and thinner caps. Of course, these thinner caps must still possess the mechanical performance of current thicker caps. In order to achieve such performance, improvements of key parameters such as stiffness and toughness are necessary without compromising other properties like processability and gas permeability (especially for caps for a sparkling beverage). Another important property is the absence of shrinkage or warpage after formation.

The use of HDPE in cap production is well known. Moreover, the use of multimodal HDPE has also previously been suggested for use in cap production. Some commercial polymer grades for caps and closure applications are multimodal HDPEs. Multimodal HDPE copolymers for cap applications however have limited stiffness, typically having a tensile modulus value around 900 MPa. To produce thinner caps, stiffness needs to be higher.

The present inventors sought new HDPE blends, developed in particular for the cap and closure market, which possess improved (i.e. higher tensile modulus). To add to the challenge however, these improvements must not be at the expense of processability of the polymer or the appearance of any article formed. Thus, processability should be maintained or even improved to meet customer needs. Injection moulded articles are produced rapidly and any reduction in processability can increase cycle times and hence reduce process efficiency. Improvement in tensile modulus should also not be at the expense of ESCR and should not encourage warpage or shrinkage.

The present inventors have found surprisingly that multimodal HDPE combined with at least one COC offer an ideal solution to the problem of the invention. Remarkably, this combination, at particular weight ratios, enables very high tensile modulus values without loss of other critical properties.

The term COC refers to a cyclic olefin copolymer. These copolymers are based on the copolymerisation of ethylene or propylene with at least one cyclic comonomer. That cyclic comonomer is often a norbornene type compound. Such a COC compound is illustrated in scheme 1 below:

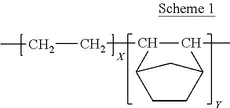

In contrast with semi-crystalline polyethylene or polypropylene, COC polymers are totally amorphous. This class of polyolefins have been developed for various applications such as transparent mouldings for use in optical data storage. More recently, the COCs have been blended with polyethylenes for use as packaging of drugs, medical devices and diagnostic disposables. Blow moulded film products comprising COC are used in blister packs, shrink films and stand up pouches. The manufacturer also suggests its COC compounds for use in high voltage applications instead of PTFE.

There have also been suggestions for blends of COC with olefins. The combination of HDPE and COC has been shown to improve heat deflection temperature and tensile modulus (Topas Blend brochure).

Blends of cyclic olefin polymers and elastomers have been used to manufacture syringe caps. In US2010/0298779 a syringe cap made from a thermoplastic elastomer and a cyclic olefin polymer is described.

There are numerous disclosures of cyclic olefin polymers being used in film manufacture. In US2009/0020898, the combination of polyethylene and cyclic olefin polymers is said to reduce defect numbers in films.

JP2011025637 describes a multilayer film in which one layer comprises a cyclic olefin based resin, a lower density polyethylene and optionally an HDPE.

WO2013/101699 describes films in which alternating layers of cyclic olefin polymer and HDPE are employed.

JP2010-234660 describes a multilayer film in which one layer comprises a cyclic olefin based resin, a lower density polyethylene and optionally an HDPE.

JP05-230147 describes the production of certain cyclic olefin copolymers which are said to be useful in automotive part manufacture.

JP04-353540 and JP-01318052 describe blends of COCs and polyolefins such as polyethylene for moulding applications. The blends prevent scuff and scratch resistance suggesting that they are designed for automotive applications.

The present inventors have now realised that the combination of a multimodal HDPE and a COC polymer represents an ideal blend for a cap or closure. The use of COC resins causes an increase in stiffness of the HDPE. Remarkably however, this increase in tensile modulus can be achieved without significant reductions in other valuable cap mechanical properties, in particular ESCR. Furthermore, the manufacturers of COC products such as TOPAS suggest in their product literature (Topas blend brochure) that the addition of COC increases warpage and yet we observe less shrinkage in our caps than occurs using a conventional filler such as talc.

The combination therefore of multimodal HDPE and COC offers a new blend for cap and closure manufacture with remarkable properties. The combination therefore of a multimodal HDPE and COC offers excellent blend properties in terms of ESCR, stiffness and shrinkage, ideally tailored for cap and closure manufacture.

### SUMMARY OF INVENTION

Viewed from one aspect the invention provides a polymer composition comprising:
(A) at least 80 wt % of a multimodal high density polyethylene having a density of 940 kg/m³ or more; and
(B) 1 to 14 wt % of a cyclic ethylene copolymer or cyclic propylene copolymer.

Viewed from another aspect the invention provides an injection or compression moulded article, preferably a cap or closure, comprising such as consisting of, a polymer composition comprising:
(A) at least 80 wt % of a multimodal high density polyethylene having a density of 940 kg/m³ or more; and
(B) 1 to 14 wt % of a cyclic ethylene copolymer or cyclic propylene copolymer.

Viewed from another aspect the invention provides a process for the manufacture of an injection or compression moulded article such as a cap or closure, said process comprising blending, preferably in an extruder,
(A) at least 80 wt % of a multimodal high density polyethylene having a density of 940 kg/m³ or more; and
(B) 1 to 14 wt % of a cyclic ethylene/propylene copolymer to form a polymer composition;

optionally pelletizing the polymer composition to form pellets; and

injection or compression moulding the formed pellets or polymer composition to form said article.

Viewed from another aspect the invention provides the use of a polymer composition as hereinbefore defined in injection or compression moulding, preferably for the manufacture of a cap or closure.

### DEFINITIONS

The polymer composition of the invention is also referred to herein as the polymer blend of the invention.

The term cyclic ethylene copolymer or cyclic propylene copolymer refers to a polymer obtained by the copolymerisation of ethylene or propylene with at least one cyclic monomer.

The term cyclic monomer refers to any polymerisable monomer which contains a ring in which a double bond is present within that ring, e.g. norbornene:

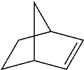

or derivatives thereof.

### DETAILED DESCRIPTION OF INVENTION

This invention relates to a polymer composition for use in the manufacture of compression moulded or injection moulded articles, in particular caps and closures. These caps and closures possess high stiffness without compromising on other mechanical properties, in particular ESCR and shrinkage properties. The blends of the invention contain at least one cyclic olefin copolymer called COCs herein. The copolymer has an olefin component which is derived from ethylene or propylene, preferably ethylene. That olefin is copolymerised with a cyclic monomer such as norbornene. Cyclic monomers comprise at least one ring, such as one ring, two rings or three rings that may be fused. The monomer must contain a polymerisable double bond and that double bond must be present within a ring structure. Styrene therefore is not a cyclic monomer according to the invention as its double bond is outside the ring and the double bonds of the phenyl ring are not polymerisable. Ideally, cyclic olefin monomers of interest will contain a bridgehead carbon atom. The total number of carbon atoms in a cyclic olefin monomer is ideally up to 20. Preferably, there should be no atoms other than C or H present in the monomer.

In theory two or more cyclic monomers can be used in the COC of the invention although ideally only one cyclic monomer is employed.

Cyclic monomers of interest include dihydrodicyclopentadiene, phenyl norbornene and derivatives thereof and tetracyclododecene. The cyclic olefin monomers are preferably derivatives of cyclopentadiene (CPD) or dicyclopentadiene (DCPD). Other cyclic olefins of interest include cyclohexene, 8,9,10-trinorborn-2-ene (norbornene) or 1,2,3,4,4a,5,8,8a-octahydro-1,4:5,8-dimethanonaphthalene.

Derivatives of norbornene of interest in the invention include 2-norbornene, 5-methyl-2-norbornene, 5,5-dimethyl-2-norbornene, 5-ethyl-2-norbornene, 5-butyl-2-norbornene, 5-ethylidene-2-norbornene, 5-phenyl-2-norbornene, 5-phenyl-5-methyl-2-norbornene, 5-hexyl-2-norbornene, 5-octyl-2-norbornene, and 5-octadecyl-2-norbornene. The use of norbornene itself is preferred.

In one embodiment, the copolymers are made from the polymerization of norbornene and ethylene/propylene by the ring-opening metathesis polymerization (ROMP). The polymers can be random or block.

Typically, in the COC polymer there is an excess of the cyclic monomer relative to the olefin present. Cyclic monomer content may therefore range from 50 to 95 wt % of the COC polymer. A preferred COC polymer is formed through the copolymerisation of norbornene and ethylene. COC polymers are commercial products and can be bought from suppliers such as Dow and TOPAS.

The COC can in some way be considered a filler type material. Unlike other fillers however such as talc, COC has low density. It is preferred if the density of the COC is in the range of 1000 to 1200 kg/m³, such as 1000 to 1100 kg/m³.

The COC polymers are known to have very high tensile modulus values and hence high rigidity, strength and hardness. The tensile modulus of the COC polymer is ideally at least 1800 MPa, such as at least 2000 MPa.

The MFR₂ of the COC polymer is preferably in the range of 0.1 to 10 g/10 min, such as 0.5 to 8 g/10 min, such as 1 to 5 g/10 min.

The glass transition temperature of the COC polymer is ideally at least 65° C.

The COC polymers also generally possess high transparency, good heat resistance and high barrier resistance. They are also useable with food and drink.

HDPE Component

The polymer composition of the invention comprises a multimodal high density ethylene polymer and may be an ethylene homopolymer or an ethylene copolymer. By ethylene copolymer is meant a polymer the majority by weight of which derives from ethylene monomer units. The comonomer contribution preferably is up to 10% by mol, more preferably up to 5% by mol. Ideally however there are very low levels of comonomer present in the polymers of the present invention such as 0.1 to 2 mol %, e.g. 0.1 to 1 mol %.

The other copolymerisable monomer or monomers are preferably C3-20, especially C3-10, alpha olefin comonomers, particularly singly or multiply ethylenically unsaturated comonomers, in particular C3-10-alpha olefins such as propene, but-1-ene, hex-1-ene, oct-1-ene, and 4-methyl-pent-1-ene. The use of hexene and butene is particularly preferred. Ideally there is only one comonomer present.

It is preferred if the polymer of the invention is a copolymer and therefore comprises ethylene and at least one comonomer. Ideally that comonomer is 1-butene.

The HDPE polymer of the invention is multimodal and therefore comprises at least two components. The HDPE polymer of the invention preferably comprises (A) a lower molecular weight first ethylene homo- or copolymer component, and (B) a higher molecular weight second ethylene homo- or copolymer component.

It is generally preferred if the higher molecular weight component has an Mw of at least 5000 more than the lower molecular weight component, such as at least 10,000 more.

The HDPE of the invention is multimodal. Usually, a polyethylene comprising at least two polyethylene fractions, which have been produced under different polymerisation conditions resulting in different (weight average) molecular weights and molecular weight distributions for the fractions, is referred to as “multimodal”. Accordingly, in this sense the HDPE of the invention is multimodal. The prefix “multi” relates to the number of different polymer fractions the HPE consists of. Thus, for example, a HDPE consisting of two fractions only is called “bimodal”.

The form of the molecular weight distribution curve, i.e. the appearance of the graph of the polymer weight fraction as function of its molecular weight, of such a multimodal polyethylene will show two or more maxima or at least be distinctly broadened in comparison with the curves for the individual fractions.

For example, if a polymer is produced in a sequential multistage process, utilising reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

The HDPE polymer of the invention preferably has an MFR₂ of 10 g/10 min or less, preferably 5 g/10 min or less, such as 4 g/10 min or less, more preferably 3 g/10 min or less, especially 2 g/10 min or less. The polymer preferably has a minimum MFR₂ of 0.1 g/10 min, such as 0.3 g/10 min or more. The range 0.1 to 5 g/10 min, especially 0.5 to 3 g/10 min.

The HDPE polymer of the invention preferably has an MFR₂₁ of 8 to 800 g/10 min, such as 24 to 400 g/10 min, more preferably 40 to 320 g/10 min, most preferably 40 to 180 g/10 min.

The density of the HDPE polymer preferably is 940 kg/m³ or more. The polymers of the invention are therefore high density polyethylenes, HDPE. More preferably, the HDPE polymer has a density of 945 kg/m³ or more, still more preferably is 950 kg/m³ or more.

Furthermore, the density of the HDPE polymer preferably is 970 kg/m³ or lower, and more preferably is 965 kg/m³ or lower, such as 960 kg/m³ or lower. An ideal density range is 950 to 960 kg/m³.

Preferably, the HDPE polymer has a tensile modulus of at least 850 MPa, more preferably at least 910 MPa. Typically, the HDPE has a tensile modulus of less than 970 MPa, such as less than 950 MPa.

The HDPE polymer preferably has an environmental stress crack resistance measured as FNCT of 30 h or more, more preferably 35 h or more.

It will be appreciated that the molecular weight and molecular distribution of the polymers of the invention is important. The HDPE polymer preferably has a molecular weight distribution Mw/Mn, being the ratio of the weight average molecular weight Mw and the number average molecular weight Mn, of 10 or more, more preferably of 12 or more, still more preferably of 14 or more.

The HDPE polymer preferably has an Mw/Mn of 30 or below, more preferably of 25 or below.

The weight average molecular weight Mw of the HDPE polymer preferably is at least 50 kD, more preferably at least 80 kD, and most preferably at least 100 kD. Furthermore, the Mw of the HDPE preferably is at most 300 kD, more preferably 275 kD.

As noted above, the HDPE of use in the invention preferably comprise a lower molecular weight component (A) and a higher molecular weight component (B). The weight ratio of fraction (A) to fraction (B) in the HDPE is in the range 30:70 to 70:30, more preferably 35:65 to 65:35, most preferably 40:60 to 60:40. In some embodiments the ratio may be 45 to 55 wt % of fraction (A) and 55 to 45 wt % fraction (B), such as 45 to 52 wt % of fraction (A) and 55 to 48 wt % fraction (B). It has been found however that the best results are obtained when the HMW component is present at the same percentage or even predominates, e.g. 50 to 54 wt % of the HMW component (B) and 50 to 46 wt % fraction (A).

Fractions (A) and (B) may both be ethylene copolymers or ethylene homopolymers, although preferably at least one of the fractions is an ethylene copolymer. Preferably, the polymer comprises an ethylene homopolymer and an ethylene copolymer component.

Where one of the components is an ethylene homopolymer, this is preferably the component with the lower weight average molecular weight (Mw), i.e. fraction (A). An ideal polymer is therefore a lower molecular weight homopolymer component (A) with a higher molecular weight component (B), ideally an ethylene butene higher molecular weight component.

The lower molecular weight fraction (A) preferably has an MFR₂ of 10 g/10 min or higher, more preferably of 50 g/10 min or higher, and most preferably 100 g/10 min or higher.

Furthermore, fraction (A) preferably, has an MFR₂ of 1000 g/10 min or lower, preferably 800 g/10 min or lower, and most preferably 600 g/10 min or lower.

The weight average molecular weight Mw of fraction (A) preferably is 10 kD or higher, more preferably is 20 kD or higher. The Mw of fraction (A) preferably is 90 kD or lower, more preferably 80 kD or lower, and most preferably is 70 kD or lower.

Preferably, fraction (A) is an ethylene homo- or copolymer with a density of at least 965 kg/m³.

Most preferably, fraction (A) is an ethylene homopolymer. If fraction (A) is a copolymer, the comonomer is preferably 1-butene.

The higher molecular weight fraction (B) preferably has an Mw of 60 kD or higher, more preferably of 100 kD or higher. Furthermore, fraction (B) preferably has an Mw of 500 kD or lower, more preferably of 400 kD or lower.

Preferably, fraction (B) is an ethylene homo- or copolymer with a density of less than 965 kg/m³.

Most preferably, fraction (B) is a copolymer. Preferred ethylene copolymers employ alpha-olefins (e.g. C3-12 alpha-olefins) as comonomers. Examples of suitable alpha-olefins include but-1-ene, hex-1-ene and oct-1-ene. But-1-ene is an especially preferred comonomer.

Where herein features of fractions (A) and/or (B) of the HDPE of the present invention are given, these values are generally valid for the cases in which they can be directly measured on the respective fraction, e.g. when the fraction is separately produced or produced in the first stage of a multistage process. However, the HDPE may also be and preferably is produced in a multistage process wherein e.g. fractions (A) and (B) are produced in subsequent stages. In such a case, the properties of the fractions produced in the second step (or further steps) of the multistage process can either be inferred from polymers, which are separately produced in a single stage by applying identical polymerisation conditions (e.g. identical temperature, partial pressures of the reactants/diluents, suspension medium, reaction time) with regard to the stage of the multistage process in which the fraction is produced, and by using a catalyst on which no previously produced polymer is present. Alternatively, the properties of the fractions produced in a higher stage of the multistage process may also be calculated, e.g. in accordance with B. Hagström, Conference on Polymer Processing (The Polymer Processing Society), Extended Abstracts and Final Programme, Gothenburg, Aug, 19 to 21, 1997, 4:13.

Thus, although not directly measurable on the multistage process products, the properties of the fractions produced in higher stages of such a multistage process can be determined by applying either or both of the above methods. The skilled person will be able to select the appropriate method.

A multimodal (e.g. bimodal) polyethylene as hereinbefore described may be produced by mechanical blending two or more polyethylenes (e.g. monomodal polyethylenes) having differently centred maxima in their molecular weight distributions. The monomodal polyethylenes required for blending may be available commercially or may be prepared using any conventional procedure known to the skilled man in the art. Each of the polyethylenes used in a blend and/or the final polymer may have the properties hereinbefore described for the lower molecular weight component, higher molecular weight component and the HDPE, respectively.

The process for the manufacture of the HDPE preferably involves

polymerising ethylene and optionally at least one C3-10 alpha olefin comonomer so as to form a lower molecular weight component (A); and subsequently

polymerising ethylene and optionally at least one C3-10 alpha olefin comonomer in the presence of component (A) so as to form a higher molecular weight component (B).

It is preferred if at least one component is produced in a gas-phase reaction.

Further preferred, one of the fractions (A) and (B) of the polyethylene HDPE, preferably fraction (A), is produced in a slurry reaction, preferably in a loop reactor, and one of the fractions (A) and (B), preferably fraction (B), is produced in a gas-phase reaction.

Preferably, the multimodal polyethylene HDPE may be produced by polymerisation using conditions which create a multimodal (e.g. bimodal) polymer product, e.g. using a catalyst system or mixture with two or more different catalytic sites, each site obtained from its own catalytic site precursor, or using a two or more stage, i.e. multistage, polymerisation process with different process conditions in the different stages or zones (e.g. different temperatures, pressures, polymerisation media, hydrogen partial pressures, etc).

Preferably, the multimodal (e.g. bimodal) HDPE is produced by a multistage ethylene polymerisation, e.g. using a series of reactors, with optional comonomer addition preferably in only the reactor(s) used for production of the higher/highest molecular weight component(s) or differing comonomers used in each stage. A multistage process is defined to be a polymerisation process in which a polymer comprising two or more fractions is produced by producing each or at least two polymer fraction(s) in a separate reaction stage, usually with different reaction conditions in each stage, in the presence of the reaction product of the previous stage which comprises a polymerisation catalyst. The polymerisation reactions used in each stage may involve conventional ethylene homopolymerisation or copolymerisation reactions, e.g. gas-phase, slurry phase, liquid phase polymerisations, using conventional reactors, e.g. loop reactors, gas phase reactors, batch reactors etc. (see for example WO97/44371 and WO96/18662).

Polymer HDPEs produced in a multistage process are also designated as “in-situ” blends.

Accordingly, it is preferred that fractions (A) and (B) of the HDPE are produced in different stages of a multistage process.

Preferably, the multistage process comprises at least one gas phase stage in which, preferably, fraction (B) is produced.

Further preferred, fraction (B) is produced in a subsequent stage in the presence of fraction (A) which has been produced in a previous stage.

It is previously known to produce multimodal, in particular bimodal, olefin polymers, such as multimodal polyethylene, in a multistage process comprising two or more reactors connected in series. As instance of this prior art, mention may be made of EP 517 868, which is hereby incorporated by way of reference in its entirety, including all its preferred embodiments as described therein, as a preferred multistage process for the production of the HDPE according to the invention.

Preferably, the main polymerisation stages of the multistage process for producing the HDPE according to the invention are such as described in EP 517 868, i.e. the production of fractions (A) and (B) is carried out as a combination of slurry polymerisation for fraction (A)/gas-phase polymerisation for fraction (B). The slurry polymerisation is preferably performed in a so-called loop reactor. Further preferred, the slurry polymerisation stage precedes the gas phase stage.

Optionally and advantageously, the main polymerisation stages may be preceded by a prepolymerisation, in which case up to 20% by weight, preferably 1 to 10% by weight, more preferably 1 to 5% by weight, of the total HDPE is produced. The prepolymer is preferably an ethylene homopolymer (High Density PE). At the prepolymerisation, preferably all of the catalyst is charged into a loop reactor and the prepolymerisation is performed as a slurry polymerisation. Such a prepolymerisation leads to less fine particles being produced in the following reactors and to a more homogeneous product being obtained in the end.

The polymerisation catalysts include coordination catalysts of a transition metal, such as Ziegler-Natta (ZN), metallocenes, non-metallocenes, Cr-catalysts etc. The catalyst may be supported, e.g. with conventional supports including silica, Al-containing supports and magnesium dichloride based supports. Preferably the catalyst is a ZN catalyst, more preferably the catalyst is silica supported ZN catalyst.

The Ziegler-Natta catalyst further preferably comprises a group 4 (group numbering according to new IUPAC system) metal compound, preferably titanium, magnesium dichloride and aluminium.

The catalyst may be commercially available or be produced in accordance or analogously to the literature. For the preparation of the preferable catalyst usable in the invention reference is made to WO2004055068 and WO2004055069 of Borealis, EP 0 688 794 and EP 0 810 235. The content of these documents in its entirety is incorporated herein by reference, in particular concerning the general and all preferred embodiments of the catalysts described therein as well as the methods for the production of the catalysts. Particularly preferred Ziegler-Natta catalysts are described in EP 0 810 235.

The resulting end product consists of an intimate mixture of the polymers from the two or more reactors, the different molecular-weight-distribution curves of these polymers together forming a molecular-weight-distribution curve having a broad maximum or two or more maxima, i.e. the end product is a bimodal or multimodal polymer mixture.

It is preferred that the base resin, i.e. the entirety of all polymeric constituents, of the HDPE according to the invention is a bimodal polyethylene mixture consisting of fractions (A) and (B), optionally further comprising a small prepolymerisation fraction in the amount as described above. It is also preferred that this bimodal polymer mixture has been produced by polymerisation as described above under different polymerisation conditions in two or more polymerisation reactors connected in series. Owing to the flexibility with respect to reaction conditions thus obtained, it is most preferred that the polymerisation is carried out in a loop reactor/a gas-phase reactor combination.

Preferably, the polymerisation conditions in the preferred two-stage method are so chosen that the comparatively low-molecular polymer having no content of comonomer is produced in one stage, preferably the first stage, owing to a high content of chain-transfer agent (hydrogen gas), whereas the high-molecular polymer having a content of comonomer is produced in another stage, preferably the second stage. The order of these stages may, however, be reversed.

In the preferred embodiment of the polymerisation in a loop reactor followed by a gas-phase reactor, the polymerisation temperature in the loop reactor preferably is 85 to 115° C., more preferably is 90 to 105° C., and most preferably is 92 to 100° C., and the temperature in the gas-phase reactor preferably is 70 to 105° C., more preferably is 75 to 100° C., and most preferably is 82 to 97° C.

A chain-transfer agent, preferably hydrogen, is added as required to the reactors, and preferably 100 to 800 moles of H2/k moles of ethylene are added to the reactor, when the LMW fraction is produced in this reactor, and 50 to 500 moles of H2/k moles of ethylene are added to the gas phase reactor when this reactor is producing the HMW fraction.

In the production of the HDPE of the present invention, preferably a compounding step is applied, wherein the composition of the base resin, i.e. the blend, which is typically obtained as a base resin powder from the reactor, is extruded in an extruder and then pelletised to polymer pellets in a manner known in the art.

The polyethylene composition may also contain minor quantities of additives such as pigments, nucleating agents, antistatic agents, fillers, antioxidants, etc., generally in amounts of up to 5% by weight, preferably up to 2% by weight, such as up to 1 wt %.

Optionally, additives or other polymer components can be added to the HDPE during the compounding step in the amount as described above. Preferably, the HDPE obtained from the reactor is compounded in the extruder together with additives in a manner known in the art.

Blend Properties

The blend of the invention comprises 1 to 14 wt % of the COC polymer, preferably 1 to 10 wt % of the COC polymer. If the amount of COC polymer is greater than 14 wt %, then the homogeneity of the blend is compromised and we observe a reduction in toughness.

It is preferred if there is 3 to 10 wt % of the COC polymer present such as 4 to 8 wt %.

The HDPE polymer is present in an amount of at least 80 wt %, such as at least 85 wt % of the blend. Ideally there is 89 wt % or more of the HDPE. Values of 92 wt % to 94 wt % HDPE are also envisaged.

It will be appreciated that the blends can contain an additive package which typically forms up to 1 wt % of the blend which may be added as part of the HDPE, part of the COC component or separately.

The blend of the invention may also be combined with other polymer components such as other HDPEs or with other polymers such as LLDPE or LDPE. Ideally however, no such additional components are present.

The blend of the invention preferably has a tensile modulus of at least 1000 MPa, preferably at least 1050 MPa, especially 1100MPa or more. The tensile modulus is ideally at least 50 MPa higher than the tensile modulus of the HDPE used in the blend.

The blend of the invention preferably has an FNCT of no less than 90% of the FNCT of the HDPE used in the blend, such as no less than 95% of FNCT of the HDPE used in the blend (i.e. if the FNCT of the HDPE is 40 hrs then the blend should have an FNCT of 36 hrs or more, ideally 38 hrs or more). FNCT values are ideally at least 30 h, such as at least 35 h.

The tensile at break values of the blend of the invention are ideally 400% or more.

The blend of the invention can be pelletizing in an extruder to form a composition in pellet form.

The blend of the invention can be used to make injection and compression moulded articles. Articles of the invention such as caps and closures preferably comprise at least 90 wt % of the blend of the invention such as at least 95 wt % of the blend. In one embodiment, the articles consist of the blend of the invention.

Applications

The present invention also relates to an injection or compression moulded article, preferably a cap or closure, comprising a polyethylene composition/blend as described above and to the use of such a polyethylene composition for the production of an injection or compression moulded article, preferably a cap or closure. Preferably, injection moulded articles are made.

Injection moulding of the composition hereinbefore described may be carried out using any conventional injection moulding equipment. A typical injection moulding process may be carried out a temperature of 190 to 275° C.

Still further, the present invention relates to a compression moulded article, preferably a caps or closure article, comprising a polyethylene polymer as described above and to the use of such a polyethylene polymer for the production of a compression moulded article, preferably a cap or closure.

Preferably, the composition of the invention is used for the production of a caps or closure article.

The caps and closures of the invention are preferably of conventional size, designed therefore for bottles and the like. They are approximately 2 to 8 cm in outer diameter (measured across the solid top of the cap) depending on the bottle and provided with a screw. Cap height might be 0.8 to 3 cm.

Caps and closure may be provided with tear strips from which the cap detaches on first opening as is well known in the art. Caps may also be provided with liners.

Caps may clip on or be screw caps, preferably screw caps. Screw-caps can be made to fit to bottle-neck PCO 1881 (new design), or an older bottle-neck standard, e.g. Neck PCO 1810 (also called PCO 28).

Whilst the invention has been described with reference to a multimodal HDPE, it is also proposed that caps and closures formed from a blend of unimodal HDPE and the COC would have advatangeous properties. Thus, viewed from another aspect the invention provides:
(A) at least 80 wt % of a unimodal high density polyethylene having a density of 940 kg/m³ or more; and
(B) 1 to 10 wt % of a cyclic ethylene copolymer or cyclic propylene copolymer.

It will be appreciated that any parameter mentioned above is measured according to the detailed test given below. In any parameter where a narrower and broader embodiment are disclosed, those embodiments are disclosed in connection with the narrower and broader embodiments of other parameters.

The invention will now be described with reference to the following non limiting examples. The following materials are used in the examples and figures.

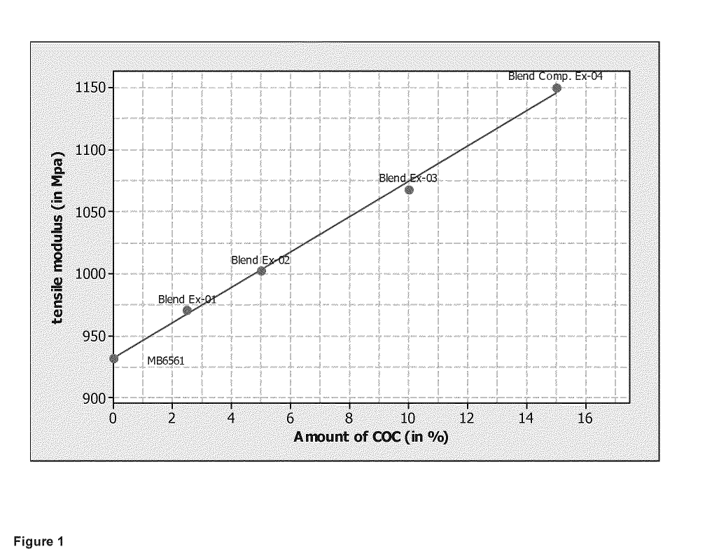

FIG. 1 shows the variation of the tensile modulus versus amount of COC (in wt %).

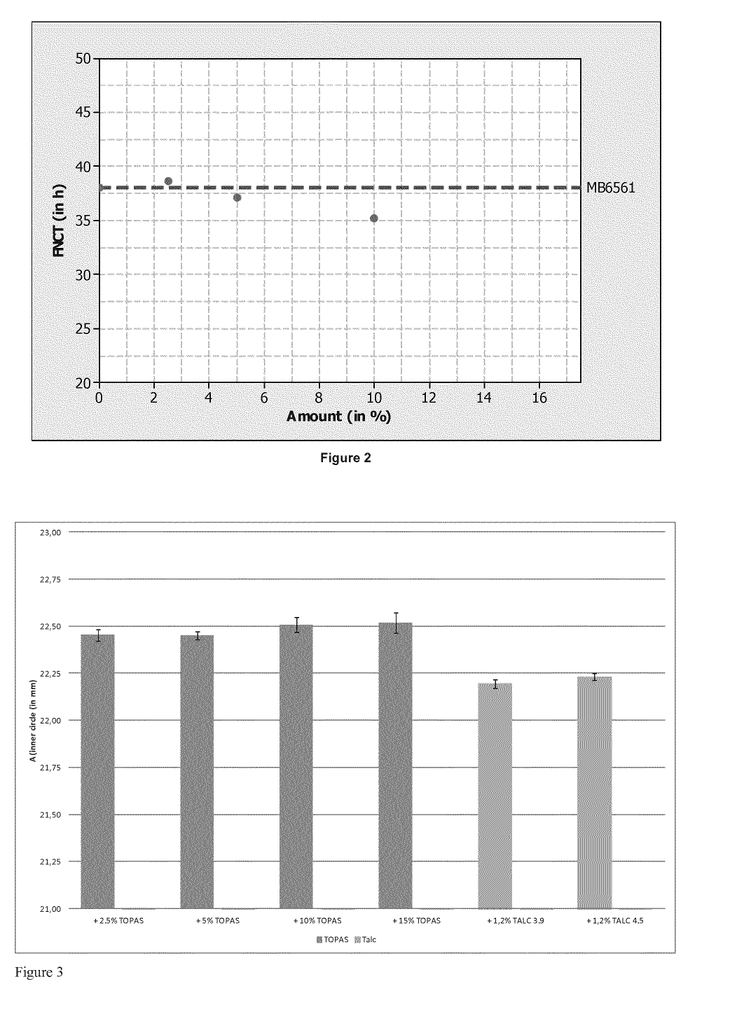

FIG. 2 show FNCT values for blends of the invention as a function of COC content relative to the HDPE polymer alone.

FIG. 3 shows shrinkage properties of formed caps for the examples of the invention compared to the same HDPE combined with talc.

### TEST METHODS:

### Melt Flow Rate

The melt flow rate (MFR) is determined according to ISO 1133 and is indicated in g/10 min. The MFR is an indication of the melt viscosity of the polymer. The MFR is determined at 190° C. for PE. The load under which the melt flow rate is determined is usually indicated as a subscript, for instance MFR₂ is measured under 2.16 kg load (condition D), MFR₅ is measured under 5 kg load (condition T) or MFR₂₁ is measured under 21.6 kg load (condition G).

The quantity FRR (flow rate ratio) is an indication of molecular weight distribution and denotes the ratio of flow rates at different loads. Thus, FRR_{21/2} denotes the value of MFR₂₁/MFR₂.

### Density

Density of the polymer was measured according to ISO 1183/1872-2B.

For the purpose of this invention the density of the blend can be calculated from the densities of the components according to:

$${ρ}_{b} = {\sum }_{i} {w}_{i} \cdot {ρ}_{i}$$

where p_{b} is the density of the blend,
wₑ is the weight fraction of component “i” in the blend and
pᵢ is the density of the component “i”.

Comonomer Content (% wt and % mol) was determined by using ¹³C-NMR. The ¹³C-NMR spectra were recorded on Broker 400 MHz spectrometer at 130° C. from samples dissolved in 1,2,4-trichlorobenzene/benzene-d₆ (90/10 w/w). Conversion between % wt and % mol can be carried out by calculation.

### Molecular Weight

Molecular weight averages, molecular weight distribution (Mn, Mw,Mz MWD)

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$$\begin{matrix}{M}_{n} = \frac{{\sum }_{i = 1}^{N} {A}_{i}}{{\sum }_{i = 1}^{N} ( {A}_{i} / {M}_{i} )} & ( 1 ) \\ {M}_{w} = \frac{{\sum }_{i = 1}^{N} ( {A}_{i} {xM}_{i} )}{{\sum }_{i = 1}^{N} {A}_{i}} & ( 2 ) \\ {M}_{z} = \frac{{\sum }_{i = 1}^{N} ( {A}_{i} {xM}_{i}^{2} )}{{\sum }_{i = 1}^{N} ( {A}_{i} / {M}_{i} )} & ( 3 )\end{matrix}$$

For a constant elution volume interval ΔVᵢ, where Aᵢ, and Mᵢ, are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain) or differential refractometer (RI) from Agilent Technologies, equipped with 3 × Agilent-PLgel Olexis and 1 × Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

K_{PS}=19 ×10⁻³ mL/g,αₚₛ=0.655

K_{PE}=39×10⁻³ mL/g,α_{PE}=0.725

K_{PP}=19×10⁻³ mL/g,α_{PP}=0.725

A third order polynomial fit was used to fit the calibration data.

All samples were prepared in the concentration range of 0.5-1 mg/ml and dissolved at 160° C. for 2.5 hours for PP or 3 hours for PE under continuous gentle shaking.

### Tensile Properties

Tensile properties were measured on injection moulded samples according to ISO 527-2, Specimen type Multipurpose bar 1A, 4 mm thick. Tensile modulus was measured at a speed of 1 mm/min. Sample preparation was done acc ISO 1872-2

### Environmental Stress Crack Resistance

Environmental Stress Crack Resistance (ESCR) may be measured according to the full notch creep test method (FNCT) according to ISO/DIS 16770 at 50° C. with a notch depth of 1 mm and specimen dimensions 6 mm×6 mm×90 mm. The solvent used was 2 wt % Arcopal N110 in deionized water. Compression moulded samples were employed (ISO 1872-2), cooling rate at compression moulding: 15 K/min.

Time to failure (t_{ƒ}) was measured at 4 different stress levels (σ) between 5-7 MPa. A plot of log(t_{ƒ}) vs. log(σ) was fitted with a straight line and a equation of the form log(t_{ƒ})=A log(σ)+B. FNCT value at 6 MPa stress is then calculated based on linear interpolation using the equation.

### EXAMPLES

The following materials are used in the examples of the invention:

TABLE 1

| Grades | | MFR |
|---|---|---|
| employed | Density | (190/2.16) |
| Grade | (in g/cm³) | (in g/10 min) |
| MB6561 | 0.953 | 1.6 |
| TOPAS | 1.02 | 2.0 |
| 8007F-400 | | |

MB6561 is a multimodal HDPE available from Borealis. TOPAS 8007F-400 is a cyclic olefin copolymer based on ethylene and norbornene sold by TOPAS advance polymers.

The blends of the invention have added 1500 ppm of an antioxidant package (100 ppm Irganox 1010, 300 ppm Irgafos 168, 1000 ppm CaSt) in order to avoid any degradation during the compounding step. The following blends are produced.

TABLE 2

| | | | | Blend |
|---|---|---|---|---|
| | Blend | Blend | Blend | Comp. |
| Product | Ex-01 | Ex-02 | Ex-03 | Ex-04 |
| MB6561 | 97.35 | 94.85 | 89.85 | 84.85 |
| (in wt %) | | | | |
| Antioxidant | 0.15 | 0.15 | 0.15 | 0.15 |
| (in wt %) | | | | |
| Total | 100.00 | 100.00 | 100.00 | 100.00 |
| (in wt %) | | | | |

The blends of the invention are prepared on a W&P ZSK40 line, double screw extruder, at 180° C. mass temperature and 150 rpm.

### Blend Analysis:

TABLE 3

| | MFR2 | MFR5 | FRR5/2 |
|---|---|---|---|
| Blend | 1.64 | 5.69 | 3.5 |
| Ex-01 | | | |
| Blend | 1.60 | 5.85 | 3.7 |
| Ex-02 | | | |
| Blend | 1.66 | 6.04 | 3.6 |
| Ex-03 | | | |
| C Blend | 1.70 | 6.14 | 3.6 |
| Ex-04 | | | |

### Mechanicals Testing: Tensile Modulus

Tensile testing was conducted on injection moulded specimens at 23° C.−room temperature.

A clear linear correlation is shown between the tensile modulus and the amount of COC added (See FIG. 1). With 5% of TOPAS 8007F-400, it is possible to have a tensile modulus around 1000 MPa. Higher tensile modulus can be achieved with even higher loadings.

### Tensile at Break

Tensile at break measurements are shown in table 4 showing a clear reduction in the toughness from blend 1 to blend 4.

TABLE 4

| | Tensile |
|---|---|
| | strength |
| | at break |
| | (MPa) |
| Blend Ex-01 | 430 |
| C Blend Ex-04 | 388 |

### ESCR

ESCR can be measured in many different ways. In the present examples, we have measured using a full notch creep test (FNCT)

### FNCT Measurements

FNCT is measured on compression moulded specimens at 50° C., in 2% Arcopal N110 solution. Four stress levels (5.25, 5.75, 6.25 and 6.75 MPa) were planned to evaluate the failure time. After the specimen fails real stress values were calculated based on measured cross section area and failure time at 6.0 MPa was calculated based on log-log linear regression. Such data processing is in agreement with ISO 16770.

Only two measurements instead of 4 were obtained for blend CEx-04 at stress levels lower than 6.0 MPa; the calculated stress at 6.0 MPa is not possible for this blend.

TABLE 5

| | Calculated |
|---|---|
| | FNCT |
| | at 6 MPa |
| Compound | (in hour) |
| Ex-1 | 38 |
| Ex-2 | 37 |
| Ex-3 | 35 |
| C. Ex-4 | — |

The HDPE grade used in the experiments here was tested and found to have an FNCT of 38 h. No significant change in FNCT is therefore observed. Results are presented graphically in FIG. 2. The lack of result for C. Ex 4 with 15% COC is indicative of inhomogeneity at such a level of COC. As the level of COC increases the homogeneity of the blend is reduced, most probably through the formation of two phases. This demixing phenomenon would have an impact on the polymer performance, especially on all toughness properties.

### Caps Dimension

A further important feature of the caps is their resistance to shrinkage after moulding. With typical fillers such as talc, a degree of shrinkage is observed in a formed cap. In contrast, the use of COC shows almost no shrinkage. In FIG. 3, we show the inner circle diameter after cap formation for blends of the invention compared to a corresponding blend with talc (Talc 3.9 is Talc HAR T84 provided by Imerys, Talc 4.5 is Talc JETFINE 3CA provided by Imerys) as opposed to the COC polymer. The circle diameter based on the mould and no shrinkage should be between 22.25 to 22.55 mm. The caps of the invention barely shrink at all. The talc solution shrinks more.

1. A polymer composition comprising:
(A) at least 80 wt % of a multimodal high density polyethylene having a density of 940 kg/m³ or more; and
(B) 1 to 14 wt % of a cyclic ethylene copolymer or cyclic propylene copolymer.

2. A composition as claimed in claim 1 wherein there is 1 to 10 wt % of component (B).

3. A composition as claimed in claim 1 having a tensile modulus of at least 1000 MPa.

4. A composition as claimed in claim 1 wherein the cyclic copolymer is a cyclic ethylene copolymer.

5. A composition as claimed in claim 1 wherein the cyclic copolymer is a copolymer of ethylene and norbornene.

6. A composition as claimed in claim 1 wherein the cyclic copolymer comprises 50 to 95 wt % of a cyclic comonomer.

7. A composition as claimed in claim 1 having an FNCT of at least 30 hrs.

8. A composition as claimed in claim 1 wherein the multimodal high density polyethylene is a copolymer.

9. A composition as claimed in claim 1 wherein the multimodal high density polyethylene has an MFR₂ of 0.1 to 5 g/10 min.

10. A composition as claimed in claim 1 wherein the multimodal high density polyethylene has a density of 950 to 960 kg/m³.

11. A composition as claimed in claim 1 wherein the multimodal high density polyethylene comprises a lower Mw ethylene homopolymer component and a higher Mw ethylene copolymer component.

12. An injection or compression moulded article comprising a polymer composition as claimed in claim 1.

13. A cap or closure comprising a polymer composition as claimed in claim 1.

14. A process for the manufacture of an injection or compression moulded article, said process comprising blending,
(A) at least 80 wt % of a multimodal high density polyethylene having a density of 940 kg/m³ or more; and
(B) 1 to 14 wt % of a cyclic ethylene/propylene copolymer to form a polymer composition;
optionally pelletizing the polymer composition to form pellets; and
injection or compression moulding the formed pellets or polymer composition to form said article.

15. (canceled)

16. A composition as claimed in claim 1 wherein there is 4 to 8 wt % of component (B).

17. A composition as claimed in claim 1 having a tensile modulus of at least 1100 MPa.

18. A composition as claimed in claim 1 having an FNCT of at least 35 hrs.

19. A composition as claimed in claim 1 wherein the multimodal high density polyethylene comprises a lower Mw ethylene homopolymer component and a HMW ethylene 1-butene copolymer component.

20. The process of claim 14, wherein components (A) and (B) are blended in an extruder.
